(19) United States
(12) Patent Application Publication
(10) Pub. No.: US 2025/0365630 A1
(43) Pub. Date: Nov. 27, 2025

(54) COMMUNICATION METHOD, REPEATER NODE, NON-TRANSITORY COMPUTER-READABLE MEDIUM, CHIPSET AND SYSTEM

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/293,857

(22) Filed: Aug. 7, 2025

Related U.S. Application Data
(63) Continuation of application No. PCT/JP2024/004393, filed on Feb. 8, 2024.
(60) Provisional application No. 63/445,077, filed on Feb. 13, 2023.

(51) Int. Cl. H04W 36/30; H04W 76/27

(52) U.S. Cl. CPC H04W 36/305; H04W 76/27

(57) ABSTRACT

A communication method using a relay apparatus including a relay device that performs relay operation of relaying a radio signal transmitted between a network and a user equipment, and a control terminal that receives a control signal used for control of the relay device from the network, the communication method including the steps of: starting, by the control terminal in a radio resource control (RRC) connected state in a first cell, an RRC connection re-establishment procedure to a second cell based on detection of a radio link failure (RLF) in the first cell; and controlling, by the relay apparatus, the relay operation based on whether the second cell is the same cell as the first cell when the RRC connection re-establishment to the second cell is successful.

### RELATED APPLICATIONS

The present application is a continuation based on PCT Application No. PCT/JP2024/004393, filed on Feb. 8, 2024, which claims the benefit of U.S. Provisional Patent Application No. 63/445,077 filed on Feb. 13, 2023. The content of which is incorporated by reference herein in their entirety.

### TECHNICAL FIELD

The present disclosure relates to a communication method and a relay apparatus used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus that is a type of relay apparatus relaying radio signals between the network and a user equipment and can be controlled from a network is attracting attention (see, for example, Non-Patent Literature 1). Such a repeater apparatus can extend the coverage of the base station while suppressing occurrence of interference by, for example, amplifying a radio signal received from the base station and transmitting the radio signal through directional transmission. Such a repeater apparatus is referred to as a network-controlled repeater (NCR).

### CITATION LIST

### Non-Patent Literature

Non-Patent Literature 1: 3GPP Contribution: RP-213700, “New SI: Study on NR Network-controlled Repeaters”

### SUMMARY

A communication method according to a first aspect is a communication method using a relay apparatus including a relay device configured to perform a relay operation of relaying a radio signal transmitted between a network and a user equipment, and a control terminal configured to receive a control signal used for control of the relay device from the network, the communication method including the steps of: receiving, by the control terminal, a control configuration used for control of the relay device from the network; starting, by the control terminal, an RRC connection re-establishment procedure based on detection of a radio link failure (RLF); and releasing, by the control terminal, the control configuration in response starting the RRC connection re-establishment procedure.

A communication method according to a second aspect is a communication method using a relay apparatus including a relay device configured to perform a relay operation of relaying a radio signal transmitted between a network and a user equipment, and a control terminal configured to receive a control signal used for control of the relay device from the network, the communication method including the steps of: starting, by the control terminal in a radio resource control (RRC) connected state in a first cell, an RRC connection re-establishment procedure to a second cell based on detection of a radio link failure (RLF) in the first cell; and controlling, by the relay apparatus, the relay operation based on whether the second cell is the same cell as the first cell when the RRC connection re-establishment to the second cell is successful.

A relay apparatus according to a third aspect includes a relay device configured to perform a relay operation of relaying a radio signal transmitted between a network and a user equipment; and a control terminal configured to receive a control signal used for control of the relay device from the network, wherein the control terminal starts a radio resource control (RRC) connection re-establishment procedure to a second cell based on detection of a radio link failure (RLF) in a first cell when the control terminal is in an RRC connected state in the first cell, and controls the relay operation based on whether the second cell is the same cell as the first cell when the RRC connection re-establishment to the second cell is successful.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario of an NCR apparatus (relay apparatus) according to an embodiment.

FIG. 5 is a diagram illustrating an example of an application scenario of the NCR apparatus according to the embodiment.

FIG. 6 is a diagram illustrating an example of a control method for the NCR apparatus according to the embodiment.

FIG. 7 is a diagram illustrating an example of a configuration of a protocol stack in a mobile communication system including the NCR apparatus according to the embodiment.

FIG. 8 is a diagram illustrating a specific example of a configuration of a mobile communication system 1 having an NCR apparatus according to the embodiment.

FIG. 9 is a diagram illustrating an example of the configuration of the NCR apparatus according to the embodiment.

FIG. 10 is a diagram illustrating a configuration of a user equipment (UE) according to the embodiment.

FIG. 11 is a diagram illustrating an example of a configuration of a gNB (base station) according to the embodiment.

FIG. 12 is a diagram illustrating a first scenario according to a first embodiment.

FIG. 13 is a diagram illustrating a second scenario according to the first embodiment.

FIG. 14 is a diagram illustrating an operation example of an NCR apparatus (NCR-MT) according to the first embodiment.

FIG. 15 is a diagram illustrating a first operation example of the NCR apparatus (NCR-MT) according to the first embodiment.

FIG. 16 is a diagram illustrating a second operation example of the NCR apparatus (NCR-MT) according to the first embodiment.

FIG. 17 is a diagram illustrating a third operation example of the NCR apparatus (NCR-MT) according to the first embodiment.

FIG. 18 is a diagram illustrating a scenario according to a second embodiment.

FIG. 19 is a diagram illustrating an operation example of a mobile communication system according to the second embodiment.

FIG. 20 is a diagram illustrating an operation example of the mobile communication system according to a variation of the second embodiment.

FIG. 21 is a diagram illustrating an RIS apparatus (relay apparatus) according to a third embodiment.

FIG. 22 is a diagram illustrating an RIS apparatus according to the third embodiment.

FIG. 23 is a diagram illustrating a specific PRACH scene (RO) for avoiding a possibility of collision.

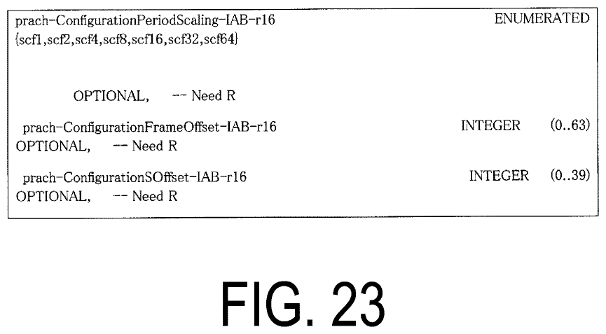

### DESCRIPTION OF EMBODIMENTS

A mobile communication system according to an embodiment is described with reference to the drawings. In the description of the drawings, the same or similar parts are denoted by the same or similar reference signs.

### (1) First Embodiment

A first embodiment will be described first. A relay apparatus according to an embodiment is a repeater apparatus (that is, an NCR apparatus) that can be controlled from a network.

### (1.1) Overview of Mobile Communication System

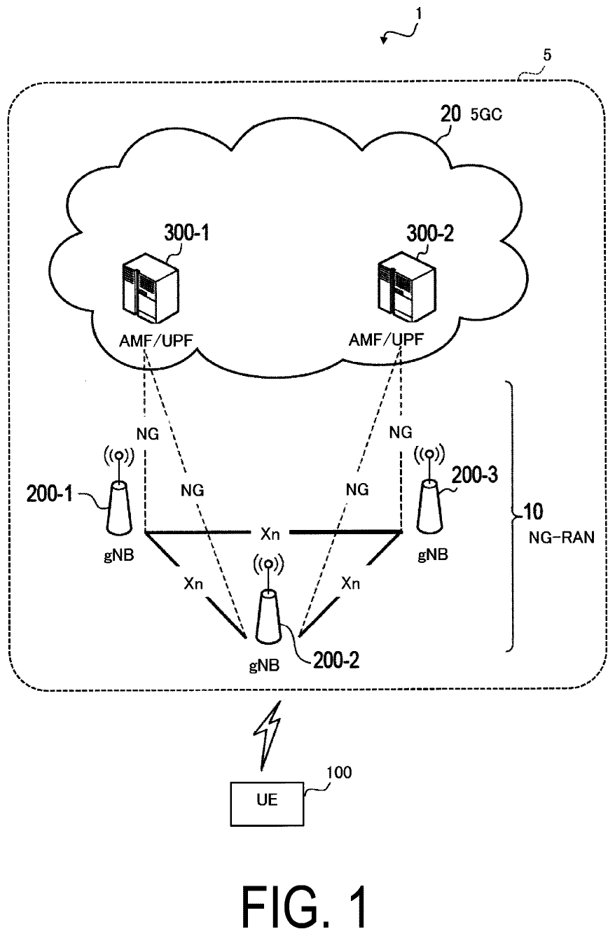

FIG. 1 is a diagram illustrating a configuration of a mobile communication system according to an embodiment.

The mobile communication system 1 complies with the 5th Generation System (5GS) of the 3rd Generation Partnership Project (3GPP) (registered trademark; the same applies hereinafter). Hereinafter, 5GS will be described by way of example, but a long term evolution (LTE) system may be at least partially applied to the mobile communication system. Alternatively, a sixth generation (6G) system may be at least partially applied to the mobile communication system.

The mobile communication system 1 includes a user equipment (UE) 100, a 5G radio access network (NG-RAN: Next Generation Radio Access Network) 10, and a 5G core network (5GC: 5G Core Network) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes a base station (referred to as “gNB” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

The gNB 200 may be functionally divided into a central unit (CU) and a distributed unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to an adjacent base station via the Xn interface, which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

The gNB can be connected to an evolved packet core (EPC) corresponding to a core network of LTE. An LTE base station can also be connected to the 5GC. The LTE base station and the gNB can be connected via an inter-base station interface.

The 5GC 20 includes an access and mobility management function (AMF) and a user plane function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

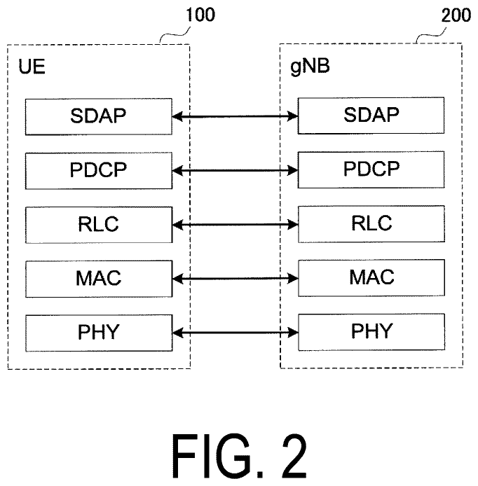

FIG. 2 is a diagram illustrating a configuration of a protocol stack of a wireless interface of a user plane handling data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 performs blind decoding of PDCCH using a radio network temporary identifier (RNTI) and acquires successfully decoded DCI as DCI addressed to the UE. The DCI transmitted from the gNB 200 is added with a cyclic redundancy code (CRC) bit scrambled by the RNTI.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20RB.

The MAC layer performs data priority control, retransmission processing using hybrid automatic repeat reQuest (HARQ), random access procedure, and the like.

Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the receiving side using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for quality of service (QOS) control in the core network, and radio bearers, which are units for QoS control in an access stratum (AS). Note that, when the RAN is connected to the EPC, the SDAP need not be provided.

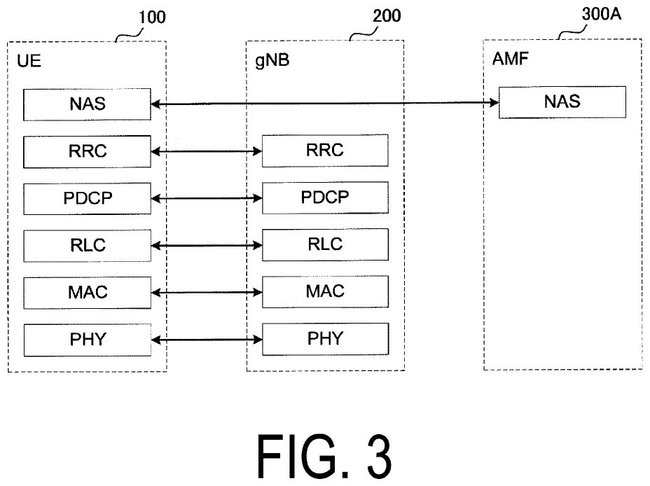

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the

UE 100 and the NAS layer of an AMF 300A. The UE 100 includes an application layer other than the protocol of the radio interface. A layer lower than the NAS layer is referred to as an AS layer.

### (1.2) Example of Application Scenario of Relay Apparatus

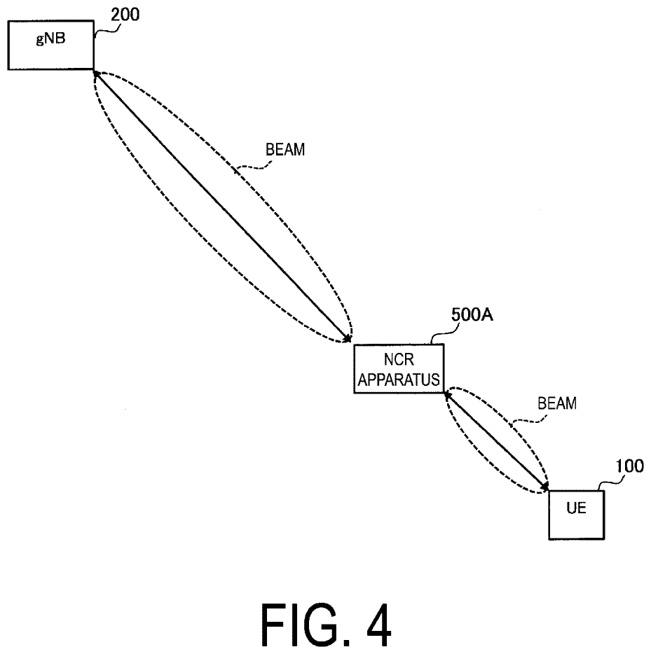

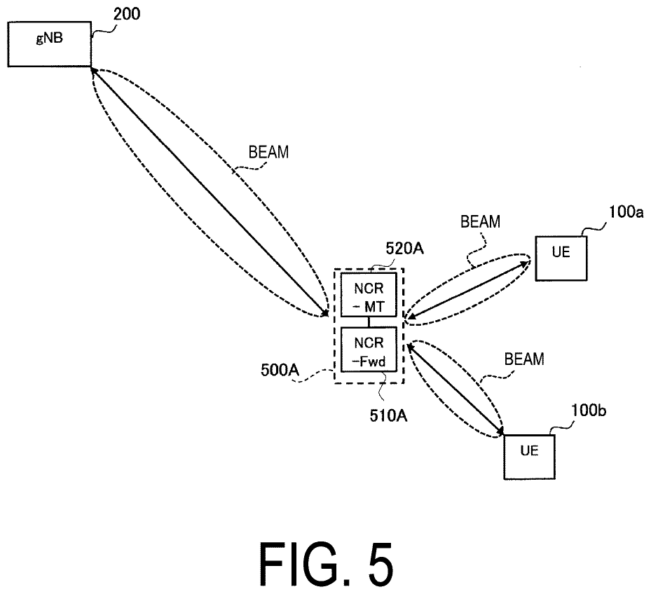

FIGS. 4 and 5 are diagrams showing an example of an application scenario of an NCR apparatus according to an embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may not communicate with the gNB 200 within a line of sight because of obstacles existing between the gNB 200 and the UE 100.

As illustrated in FIG. 4, a repeater apparatus (500A) that is a type of relay apparatus that relays radio signals between the gNB 200 and the UE 100, which is the NCR apparatus 500A that can be controlled from a network, is introduced into the mobile communication system 1. Such a repeater apparatus may be called a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

Also, as illustrated in FIG. 5, a new UE (hereinafter referred to as “NCR-MT (Mobile termination)”) 100B, which is a type of control terminal for controlling the NCR apparatus 500A, is introduced. That is, the NCR apparatus 500A includes an NCR-Fwd (Forward) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A. Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. The NCR-MT 520A also has the same function as that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wirelessly. Alternatively, the NCR-MT 520A may be configured integrally with the NCR-Fwd 510A. The NCR-MT 520A and the NCR-Fwd 510A may be fixedly installed, for example, at the coverage edge (cell edge) of the gNB 200, or on a wall or window of a building. The NCR-MT 520A and the NCR-Fwd 510A may be installed, for example, in a vehicle or the like and may be mobile. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or quasi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beamforming, the NCR-Fwd 510A may perform null forming (so-called null steering) toward the UE 100 which is not a communication partner (not illustrated) and/or a neighboring gNB 200 (not illustrated) to curb interference.

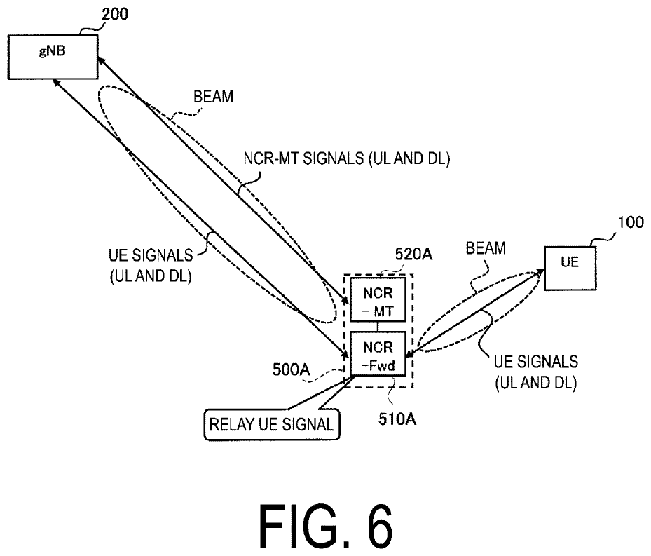

FIG. 6 is a diagram illustrating an example of a control method for the NCR apparatus 500A according to the embodiment. As illustrated in FIG. 6, the NCR-Fwd 510A relays radio signals (also referred to as “UE signals”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. The radio link between the NCR-Fwd 510A and the UE 100 is also referred to as an “access link”. The radio link between the NCR-Fwd 510A and the gNB 200 is also referred to as a “backhaul link”.

The NCR-MT 520A transmits and receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A wireless link between the NCR-MT 520A and the gNB 200 is also referred to as a “control link.”

The gNB 200 directs a beam to the NCR-MT 520A based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

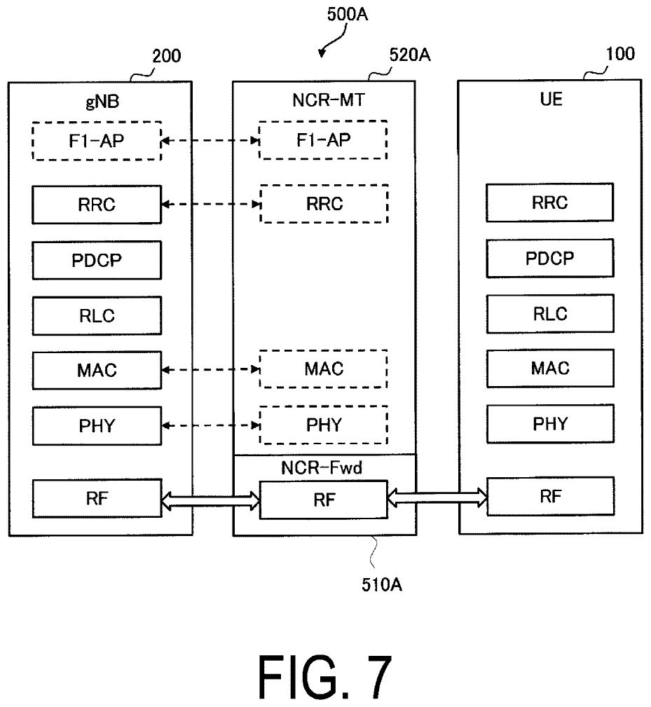

FIG. 7 is a diagram illustrating an example of a configuration of a protocol stack in the mobile communication system 1 having the NCR apparatus 500A according to an embodiment. The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes at least one layer (entity) selected from the group consisting of PHY, MAC, RRC, and application protocol (F1-AP). The F1-AP is a type of a fronthaul interface. The NCR-MT 520A exchanges signaling with the gNB 200 using at least one of PHY, MAC, RRC, and F1-AP. When the NCR-MT 520A is a type or part of a base station, the NCR-MT 520A may exchange signaling with the gNB 200 using an Xn AP (Xn-AP), which is an interface between base stations. The NCR-MT 520A may also include a NAS layer (entity). The NAS layer allows the NCR-MT 520A to exchange signaling with the AMF 300A. The NAS layer may constitute an upper layer for the NCR-MT 520A.

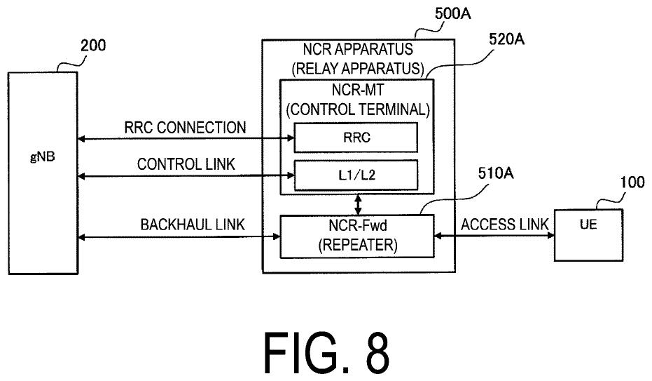

FIG. 8 is a diagram illustrating a specific example of a configuration of the mobile communication system 1 including the NCR apparatus 500A according to the embodiment.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

Further, a control link is established between the gNB 200 and layer 1 and/or layer 2 (L1/L2) of the NCR-MT 520A. The L1/L2 of the NCR-MT 520A transmits and receives L1/L2 signaling to and from the gNB 200 via the control link. An RRC connection is established between the gNB 200 and the RRC of the NCR-MT 520A. The RRC of the NCR-MT 520A transmits and receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or MAC CE) and used for static or semi-static control of the NCR-Fwd 510A is also referred to as “NCR configuration information” or simply “configuration information”. Here, the RRC message may be an RRC reconfiguration message. The NCR configuration information includes, for example, information for configuring ON/OFF of the NCR-Fwd 510A. The NCR configuration information may include, for example, information for semi-static beam configuration of the NCR-Fwd 510A.

On the other hand, the NCR control signal transmitted in the DCI (and/or MAC CE) and used for dynamic control of the NCR-Fwd 510A is also referred to as “NCR control information” or simply “control information”. The NCR control information may be referred to as side control information (SCI). CRC bits of the PDCCH carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for instructing dynamic On/Off of the NCR-Fwd 510A.

For example, when the NCR-MT 520A is in an RRC connected state, the NCR apparatus 500A can turn on or off the NCR-Fwd 510A according to the NCR control information (SCI) received from the gNB 200. On the other hand, after the NCR-MT 520A transitions to an RRC inactive state, the NCR apparatus 500A can turn on or off the NCR-Fwd 510A according to the latest (last) configuration information received from the gNB 200.

Also, when a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle state because a suitable cell cannot be found in the cell selection, the NCR apparatus 500A turns off the NCR-Fwd 510A. The NCR-Fwd 510A is off during an RRC connection re-establishment procedure.

The NCR control signal may include frequency control information for designating a center frequency of a radio signal (for example, a component carrier) that is a relay target in the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information for designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information for designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100. Any of these modes may be designated (set) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode for performing single-user (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam control information for designating a transmission direction, a transmission weight, or a beam pattern when the NCR-Fwd 510A performs directional transmission. The beam control information may be associated with the frequency control information (center frequency). The beam control information may include a precoding matrix indicator (PMI). The beam control information may include beam forming angle information. When the NCR control signal received from the gNB 200 includes beam control information, the NCR-MT 520A (controller 523) controls the NCR-Fwd 510A to form a transmission directivity (beam) indicated by the beam control information. When the NCR control signal includes the beam control information, the gNB 200 can control the transmission directivity of the NCR apparatus 500A via the NCR-MT 520A.

The NCR control signal may include output control information for designating a degree to which the NCR-Fwd 510A amplifies the radio signal (amplification gain) or the transmission power. The output control information may be information indicating a difference value (that is, a relative value) between a current amplification gain or transmission power and a target amplification gain or transmission power. When the NCR control signal received from the gNB 200 includes output control information, the NCR-MT 520A (controller 523) controls the NCR-Fwd 510A so that the NCR-Fwd 510A performs change to the amplification gain or transmission power indicated by the output control information. The output control information may be associated with frequency control information (center frequency). The output control information may be information for designating any one of an amplification gain, a beamforming gain, and an antenna gain of the NCR-Fwd 510A. The output control information may be information for designating transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Example of Configuration of Each Apparatus

An example of a configuration of each apparatus in the mobile communication system 1 according to the embodiment will be described.

### (1.3.1) Example of Configuration of Relay Apparatus

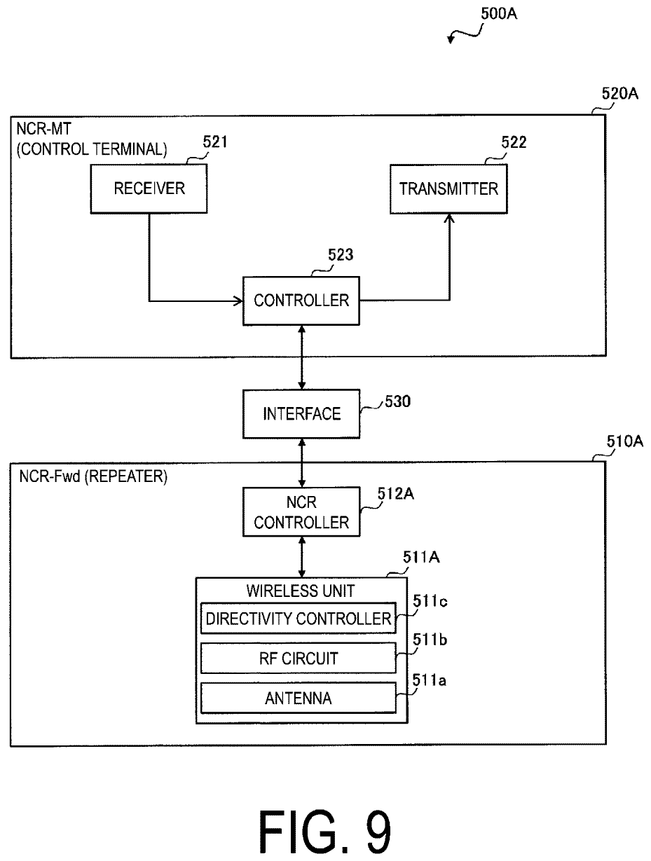

FIG. 9 is a diagram illustrating an example of a configuration of the NCR apparatus 500A (relay apparatus) according to the embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In an embodiment, the receiver 521 of the NCR-MT 520A receives signaling (NCR control signal) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

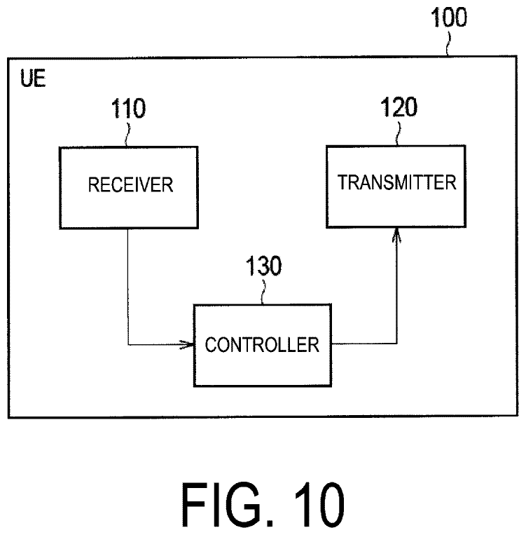

FIG. 10 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various controls and processes in the UE 100. Such processing includes processing of respective layers to be described later. The operations of the UE 100 described above and to be described below may also be an operation under the control of the controller 130. The controller 130 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

### (1.3.3) Example of Configuration of Base Station

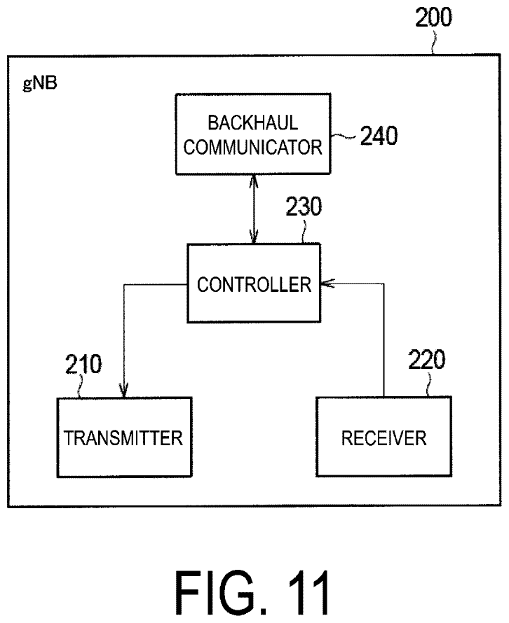

FIG. 11 is a diagram illustrating an example of a configuration of the gNB 200 (base station) according to an embodiment. The gNB 200 includes a transmitter 210, a receiver 220, a controller 230, and a backhaul communicator 240.

The transmitter 210 performs various transmissions under the control of the controller 230. The transmitter 210 includes an antenna and a transmission device. The transmission device converts a baseband signal (a transmission signal) output by the controller 230 into a radio signal and transmits the resulting signal through the antenna. The receiver 220 performs various types of reception under control of the controller 230. The receiver 220 includes an antenna and a reception device. The reception device converts a radio signal received through the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operation of the gNB 200 described above and to be described below may be an operation under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an F1 interface.

In the embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

### (1.4) Operation According to First Embodiment

As described above, when a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A transitions to the RRC idle state because no suitable cell is found in the cell selection, the NCR apparatus 500A turns off the NCR-Fwd 510A. The NCR-Fwd 510A is off during the RRC connection re-establishment procedure.

However, the NCR-MT 520A may change a serving cell (also referred to as a “camping cell”) due to a radio state such as a failure of frequency range (FR) 2. Therefore, it is worth considering what happens when the NCR-MT 520A selects another cell.

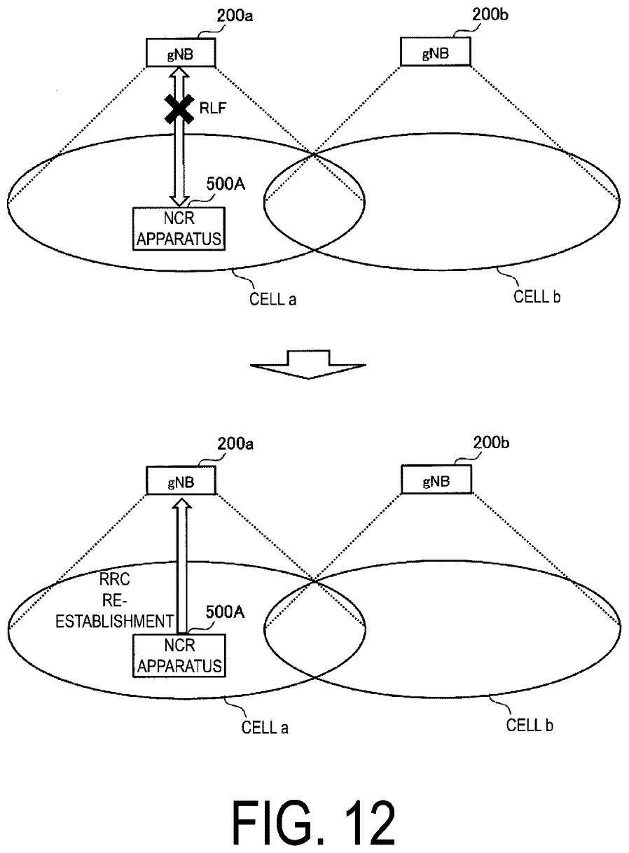

FIG. 12 is a diagram illustrating a first scenario according to the first embodiment. In the first and second scenarios below, the NCR apparatus 500A (NCR-MT 520A) is in an RRC connected state in a cell a managed by the gNB 200a. A cell b adjacent to the cell a is managed by the gNB 200b, which is different from the gNB 200a. However, the cell a and the cell b may be managed by the same gNB 200. It is assumed that the NCR apparatus 500A (NCR-MT 520A) is performing relay operation according to an NCR control signal received from the cell a (gNB 200a) (that is, NCR-Fwd 510A is on).

In the first scenario, first, the NCR-MT 520A in the RRC connected state detects (declares) an RLF for the cell a and starts the cell selection and RRC connection re-establishment. During these procedures, the NCR-Fwd 510A is turned off

Second, the NCR-MT 520A selects the same cell a through the cell selection and starts the RRC connection re-establishment procedure to the cell a. When the RRC connection re-establishment procedure to the cell a is completed successfully (that is, the RRC connection re-establishment is successful), the NCR-MT 520A maintains the RRC connected state in the cell a.

In the case of the first scenario, the inventors consider this to be efficient for the NCR-Fwd 510A to autonomously resume the relay operation according to the NCR control signal (also referred to as a “latest NCR control signal”) last received from the cell a before detecting the RLF, that is, to turn on the NCR-Fwd 510A. Since the NCR apparatus 500A has the latest NCR control signal (NCR configuration information) provided by the same cell a, the NCR apparatus 500A can resume operation with the latest NCR control signal (NCR configuration information). This avoids signaling and delay for reconfiguring the NCR apparatus 500A.

Thus, in the first scenario of the first embodiment, the NCR apparatus 500A (NCR-MT 520A) performs recovery processing of applying the latest NCR control signal (NCR configuration information) to the relay operation when the RRC connection re-establishment to the same cell is successful.

On the other hand, the gNB 200 may not want to automatically resume the operation of the NCR-Fwd 510A because the RLF has occurred in the NCR-MT 520A. Therefore, there may be an option for the gNB 200 to explicitly indicate whether to allow the NCR-Fwd 510A to perform the recovery processing, that is, whether to resume the operation or to keep the NCR-Fwd 510A off according to the latest NCR control signal.

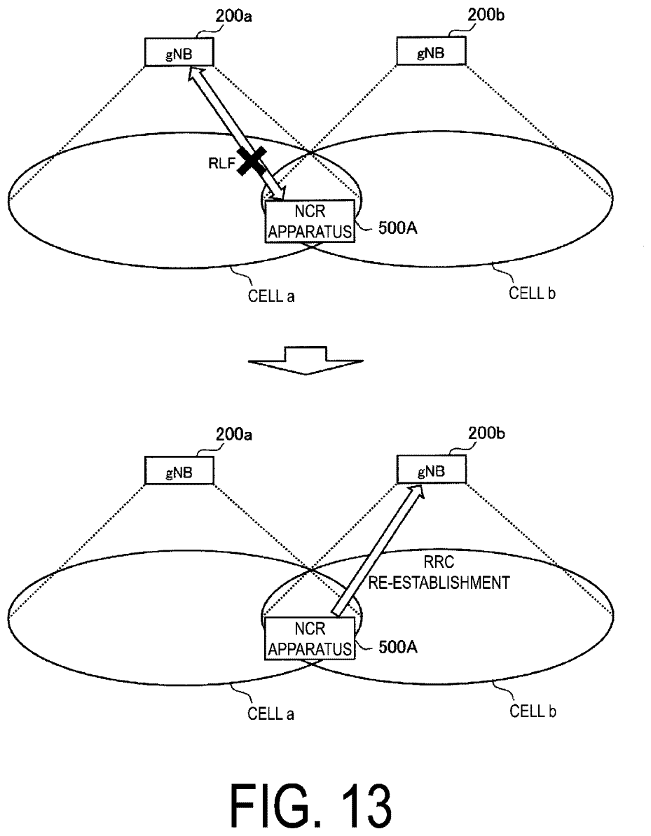

FIG. 13 is a diagram illustrating a second scenario according to the first embodiment.

In the second scenario, first, the NCR-MT 520A in the RRC connected state detects (declares) an RLF for the cell a and starts the cell selection and RRC connection re-establishment. During these procedures, the NCR-Fwd 510A is turned off.

Second, the NCR-MT 520A selects the cell b through the cell selection and performs an RRC connection re-establishment procedure to the cell b. When the RRC connection re-establishment procedure to the cell b is completed normally (that is, is successful), the NCR-MT 520A maintains the RRC connected state in the cell b.

In the case of the second scenario, the latest NCR control signal (NCR configuration information) held by the NCR-MT 520A is provided by the last serving cell a, rather than the new cell b. Therefore, the inventors consider that the NCR apparatus 500A is provided with a new NCR control signal (NCR configuration information) from the new cell b. In this case, it is preferable for the NCR-MT 520A to discard the latest NCR control signal (for example, a latest instruction by the NCR configuration information (RRC configuration) and/or the side control information) when selecting another cell b (or when transmitting an RRC re-establishment request message to another cell b).

Thus, in the second scenario of the first embodiment, when the NCR apparatus 500A (NCR-MT 520A) successfully re-establishes the RRC connection to another cell b, the NCR apparatus 500A (NCR-MT 520A) keeps the NCR-Fwd 510A off and discards the latest NCR control signal.

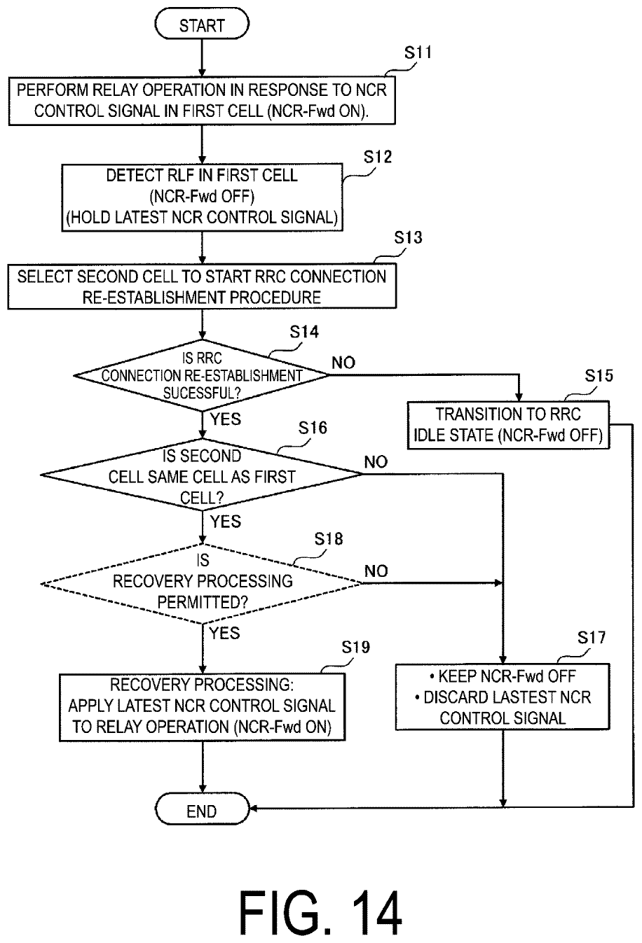

FIG. 14 is a diagram illustrating an operation example of the NCR apparatus 500A (NCR-MT 520A) according to the first embodiment. This operation is executed by the NCR apparatus 500A including the NCR-Fwd 510A that performs a relay operation of relaying a radio signal transmitted between the network 5 and the UE 100, and the NCR-MT 520A that receives a control signal (NCR control signal) used for control of the NCR-Fwd 510A from the network 5.

In the first embodiment, the NCR-MT 520A in the RRC connected state in the first cell starts the RRC connection re-establishment procedure to the second cell based on the detection of the RLF in the first cell. When the RRC connection re-establishment to the second cell is successful, the NCR apparatus 500A controls the relay operation based on whether the second cell is the same as the first cell.

Here, the first cell may be any of the cell configured and controlled by the NCR apparatus 500A (the cell provided the last configuration), the latest serving cell of the NCR apparatus 500A (the last serving cell), and the cell in which the RLF occurred (the cell caused the RLF). Alternatively, the first cell may be a cell (desired cell or planned cell) determined in advance by station placement design or the like as a cell to which the NCR apparatus 500A should be connected. On the other hand, the second cell may be any of a cell whose wireless quality satisfies a cell selection criterion, a cell discovered through the cell selection, and a target cell for RRC connection re-establishment.

As illustrated in FIG. 14, in step S11, the NCR-MT 520A in the RRC connected state in the first cell receives an NCR control signal from the first cell. The NCR control signal includes information indicating whether to turn on or off the NCR-Fwd 510A. Here, it is assumed that the NCR control signal includes information indicating that the NCR-Fwd 510A is turned on (that is, the relay operation is performed). The NCR apparatus 500A performs the relay operation according to the NCR control signal. Further, the NCR control signal may include configuration information indicating whether to permit recovery processing. Further, when the NCR apparatus 500A includes the plurality of NCR-Fwds 510A, the NCR control signal may include the configuration information indicating whether to permit recovery processing for each of the plurality of NCR-Fwds 510A. Further, the NCR control signal (NCR configuration information by RRC and/or NCR control information by L1/L2 signaling) held by the NCR apparatus 500A (NCR-MT 520A) may be referred to as an NCR-Fwd context.

In step S12, the NCR-MT 520A in the RRC connected state in the first cell detects (declares) the RLF in the first cell. For example, the NCR-MT 520A detects (declares) the RLF when a radio problem is not recovered from detection of the radio problem to expiration of the first timer (for example, a timer T310). When the NCR-MT 520A detects the RLF, the NCR-MT 520A starts a second timer (for example, timer T311) and attempts the cell selection and RRC connection re-establishment while the second timer is operating. When the RRC connection re-establishment is not successful before the second timer expires, the NCR-MT 520A transitions to the RRC idle state.

The NCR-MT 520A turns off the NCR-Fwd 510A in response to the detection of the RLF. The NCR-MT 520A also holds the latest NCR control signal.

In step S13, when the NCR-MT 520A finds a suitable second cell through the cell selection, the NCR-MT 520A starts the RRC connection re-establishment procedure for the second cell. The RRC connection re-establishment procedure includes transmission of an RRC re-establishment request message from the NCR-MT 520A to the second cell, and transmission of an RRC re-establishment message from the second cell to the NCR-MT 520A.

In step S14, the NCR-MT 520A determines whether the RRC connection re-establishment is successful. For example, when the RRC connection re-establishment is not successful before the second timer expires, the NCR-MT 520A determines that the RRC connection re-establishment has failed (step S14: NO). When it is determined that the RRC connection re-establishment has failed (step S14: NO), the NCR-MT 520A transitions from the RRC connected state to the RRC idle state in step S15. In this case, the NCR-MT 520A keeps the NCR-Fwd 510A off. Also, the NCR-MT 520A may discard the latest NCR control signal.

On the other hand, when it is determined that the RRC connection re-establishment is successful (step S14: YES), the NCR-MT 520A determines whether the second cell with which the RRC connection is re-established is the same cell as the first cell in step S16. When the second cell is a different cell from the first cell (step S16: NO), the NCR-MT 520A keeps the NCR-Fwd 510A off and discards the latest NCR control signal held by the NCR-MT 520A in step S17.

When the second cell is the same cell as the first cell (step S16: YES), the NCR-MT 520A may determine whether the recovery processing is permitted based on the configuration information received from the first cell in step S18. When the recovery processing is not permitted (step S18: NO), the NCR-MT 520A keeps the NCR-Fwd 510A off and discards the latest NCR control signal held by the NCR-MT 520A in step S17. When the recovery processing is permitted (step S18: YES), the processing proceeds to step S19.

In step S19, the NCR-MT 520A performs the recovery processing of applying the latest NCR control signal to the relay operation in the second cell, based on the fact that the second cell is the same cell as the first cell. In the present operation example, the latest NCR control signal includes information indicating that the NCR-Fwd 510A is to be turned on (that is, the relay operation is to be performed). Therefore, the NCR apparatus 500A turns on the NCR-Fwd 510A and resumes the relay operation.

### (1.4.1) First Operation Example of First Embodiment

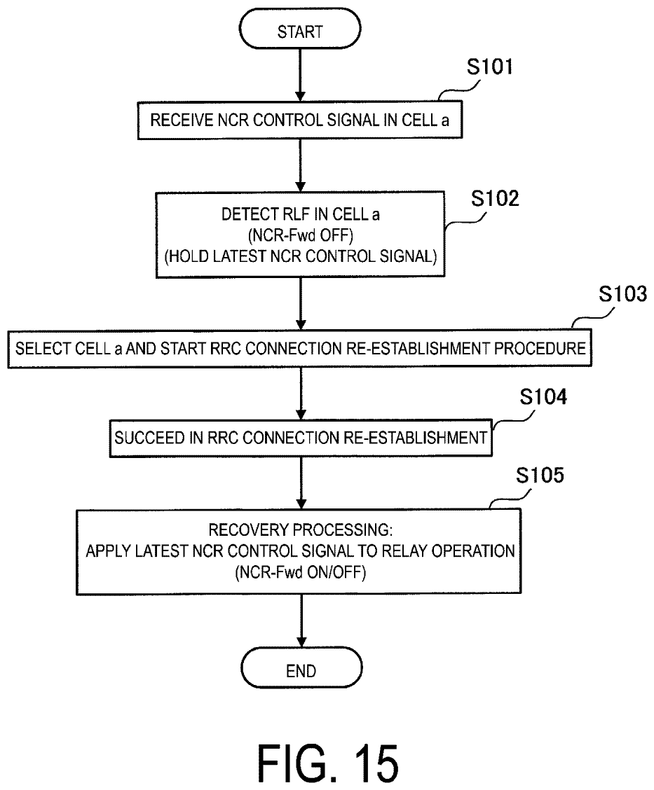

FIG. 15 is a diagram illustrating a first operation example of the NCR apparatus 500A (NCR-MT 520A) according to the first embodiment. In the present operation example, it is assumed that the first cell and the second cell are the same cell (cell a). Here, differences from the above operation example will be mainly described.

In the present operation example, when the NCR-MT 520A successfully re-establishes an RRC connection with the same cell, the NCR-MT 520A recovers the operation of the NCR-Fwd 510A according to the latest NCR control signal.

In step S101, the NCR-MT 520A is in the RRC connected state with the cell a and receives an NCR control signal (configuration and control information related to the NCR apparatus 500A) from the cell a.

In step S102, the NCR-MT 520A detects the RLF for the cell a and starts the RRC connection re-establishment procedure. Here, the NCR apparatus 500A stops (turns off) the operation of the NCR-Fwd 510A. Further, the NCR apparatus 500A holds the latest NCR control signal.

In step S103, the NCR-MT 520A selects cell a and starts the RRC connection re-establishment procedure.

In step S104, the NCR-MT 520A succeeds in re-establishing a connection with the cell a. The NCR-MT 520A may notify the upper layer of the re-establishment of a connection with the same cell.

In step S105, the NCR-MT 520A recovers the latest configuration (control) information upon re-establishment of connection with the same cell, and applies the latest configuration (control) information to the relay operation (NCR-Fwd 510A). The NCR-Fwd 510A turns on or off according to the configuration (control).

### (1.4.2) Second Operation Example of First Embodiment

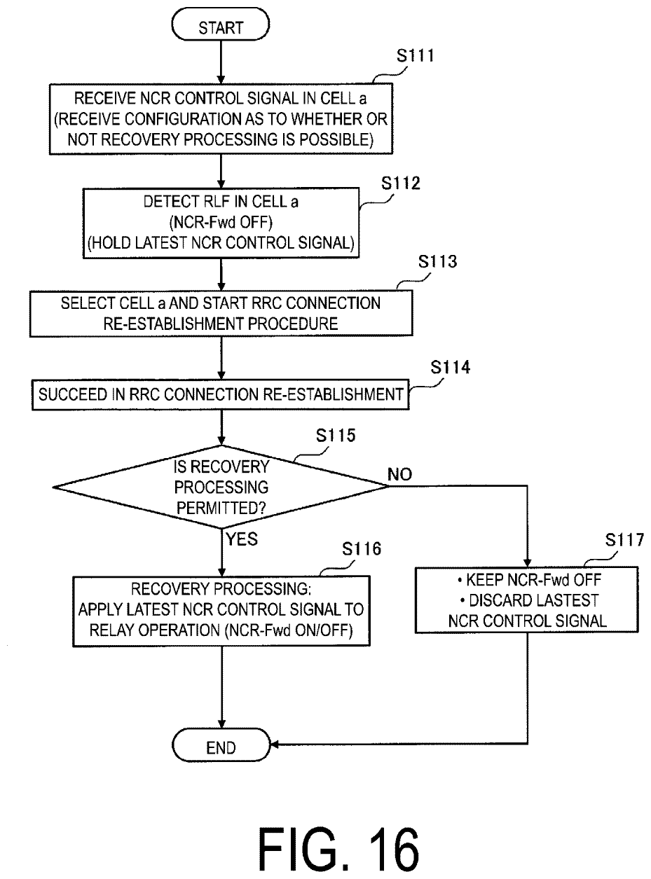

FIG. 16 is a diagram illustrating a second operation example of the NCR apparatus 500A (NCR-MT 520A) according to the first embodiment. In the present operation example, it is assumed that the first cell and the second cell are the same cell (cell a). Here, differences from the above-described operation example will be mainly described.

In the present operation example, the gNB 200 performs, on the NCR-MT 520A, a configuration of whether to permit the recovery processing of applying the latest configuration (control) to the operation of the NCR-Fwd 510A when the RRC connection re-establishment to the same cell is successful. In a case where the NCR-MT 520A does not perform the recovery processing when the RRC connection re-establishment to the same cell is successful based on the configuration, the NCR-MT 520A discards the latest configuration (control). When the NCR-MT 520A handles the plurality of NCR-Fwds 510A, the gNB 200 may configure information on whether to perform the recovery processing on the NCR-Fwd 510A (or not recover the NCR-Fwd 510A) in the NCR-MT 520A.

In step S111, the NCR-MT 520A is in the RRC connected state with the cell a and receives the NCR control signal (configuration and control information related to the NCR apparatus 500A) from the cell a. The configuration includes configuration information on whether to perform the recovery processing when re-establishing an RRC connection to the same cell.

When the NCR-MT 520A handles the plurality of NCR-Fwds 510A, the configuration information may be applied to all of the plurality of NCR-Fwds 510A. Alternatively, the configuration information may be associated with each NCR-Fwd 510A. For example, a management ID of the NCR-Fwd 510A and the configuration information may be set as a set (list). Alternatively, an operating frequency (and/or relay cell ID) and the configuration information may be set as a set by implicitly identifying the NCR-Fwd 510A using the operating frequency of the NCR-Fwd 510A and/or a cell ID of a relay cell (relay cell ID).

In step S112, the NCR-MT 520A detects the RLF for the cell a.

In step S113, the NCR-MT 520A selects cell a and starts the RRC connection re-establishment procedure.

In step S114, the NCR-MT 520A succeeds in re-establishing the RRC connection with the cell a. The NCR-MT 520A may notify the upper layer that the re-establishment to the same cell has been successful. In addition, the NCR-MT 520A may notify the upper layer of the need for operation recovery for the NCR-Fwd 510A.

When the recovery processing is permitted (step S115: YES), the NCR-Fwd 510A recovers the latest configuration (control) upon re-establishment of the RRC connection with the cell a, and applies the latest configuration (control) to the relay operation (NCR-Fwd 510A) in step S116. The NCR-Fwd 510A is turned on or off according to the configuration (control).

On the other hand, when the recovery processing is not permitted (step S115: NO), the NCR-MT 520A discards the latest configuration (control) without recovering the operation of the NCR-Fwd 510A in step S117. The discarding operation may be performed when the RLF is detected (step S112) or when the RRC connection re-establishment starts (step S113) in a case where a configuration for recovering the operation of the NCR-Fwd 510A is not performed.

Also, when the NCR-MT 520A handles the plurality of NCR-Fwds 510A, the NCR-MT 520A may perform the determination of step S115 on each of the plurality of NCR-Fwds 510A.

In the present operation example, in the RRC connection establishment procedure (step S113), the cell a (gNB 200) may transmit an RRC re-establishment message including information on whether to recover the operation of the NCR-Fwd 510A to the NCR-MT 520A. The NCR-MT 520A may perform the determination of step S115 based on the information in the RRC re-establishment message. Such an operation is also applicable to the first operation example described above.

### (1.4.3) Third Operation Example of First Embodiment

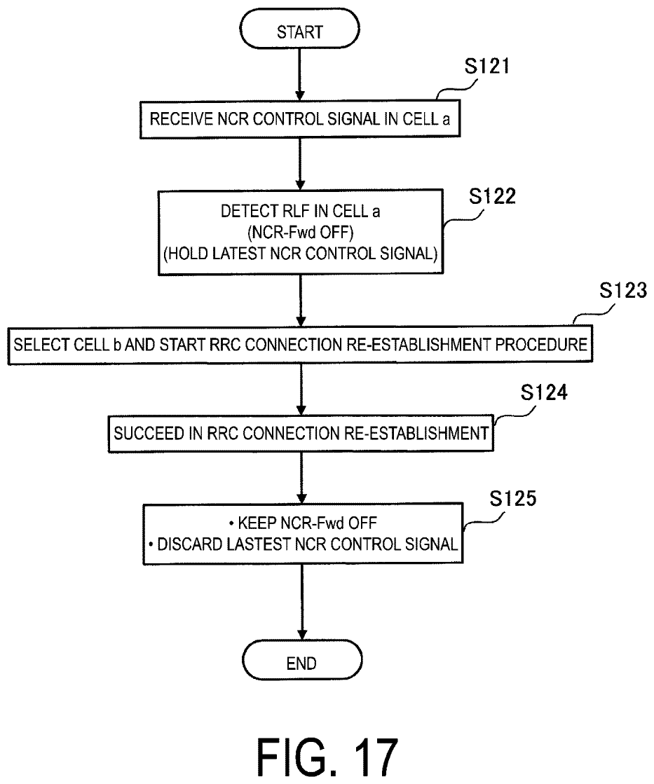

FIG. 17 is a diagram illustrating a third operation example of the NCR apparatus 500A (NCR-MT 520A) according to the first embodiment. In the present operation example, it is assumed that the first cell and the second cell are different cells (cell a and cell b). Here, the differences from the above operation example will be mainly described.

In the present operation example, when the NCR-MT 520A successfully re-establishes an RRC connection to a different cell, the operation of the NCR-Fwd 510A is not recovered (kept off). Further, when the NCR-MT 520A successfully re-establishes the RRC connection to the different cell, the NCR-MT 520A discards the latest NCR control signal (information on configuration and control). When the RRC connection to the different cell is successfully re-established, the inventors consider that a new NCR control signal is provided from the new cell.

The configuration and control of an original cell are discarded because malfunction is likely to occur in the new cell due to the configuration and control of the original cell.

In step S121, the NCR-MT 520A is in the RRC connected state with the cell a and receives an NCR control signal (configuration and control information related to NCR apparatus 500A) from the cell a.

In step S122, the NCR-MT 520A detects the RLF for the cell a and starts an RRC connection re-establishment procedure. Here, the NCR apparatus 500A stops (turns off) the operation of the NCR-Fwd 510A.

In step S123, the NCR-MT 520A selects the cell b and starts an RRC connection re-establishment procedure.

In step S124, the NCR-MT 520A succeeds in re-establishing the RRC connection with the cell b. The NCR-MT 520A may notify the upper layer of the re-establishment of the RRC connection with a different cell.

In step S125, the NCR-MT 520A keeps the NCR-Fwd 510A off. The NCR-MT 520A also discards the latest NCR control signal (configuration/control).

### (1.5) Variation of First Embodiment

In the first embodiment described above, an example in which the NCR apparatus 500A controls the relay operation based on whether the second cell is the same cell as the first cell has been described.

However, an effective area in which the same NCR control signal can be used in other cells may be set to the NCR-MT 520A from the network 5 (gNB 200). The effective area is an area consisting of one or more cells. For example, the gNB 200 transmits an NCR control signal including configuration information and/or control information related to the relay operation and area information indicating the effective area of the configuration information and/or the control information to the NCR-MT 520A. The area information may be a list of cell IDs or (a list of) IDs of frequencies. The area information may be information for identifying the gNB 200, such as a gNB ID or an arbitrary ID for identifying the gNB (for example, a part of the gNB ID may be (shortened) used, or the ID may be a number form different from the gNB ID). The information may be broadcast in the SIB by the gNB 200, and the UE 100 may use the broadcast information to determine whether the cell in which RRC has been re-established belongs to the effective area. When the NCR-MT 520A detects the RLF for the first cell and successfully re-establishes the RRC connection to the second cell, the NCR-MT 520A determines whether the second cell belongs to the effective area. When the NCR-MT 520A determines that the second cell belongs to the effective area, the NCR-MT 520A performs recovery processing of applying the configuration information and/or control information received from the first cell to the relay operation. On the other hand, when the NCR-MT 520A determines that the second cell does not belong to the effective area, the NCR-MT 520A discards the configuration information and/or control information received from the first cell and keeps the NCR-Fwd 510A off.

Such an effective area may be determined by negotiation between the gNBs 200. For example, the gNB 200 transmits the NCR control signal (NCR configuration information) to be set to the NCR apparatus 500A of its own cell to an adjacent gNB. When the adjacent gNB determines that the NCR control signal is applicable to its own cell, the adjacent gNB may permit its own cell as an effective area of the NCR control signal.

### (2) Second Embodiment

A second embodiment will be described mainly with respect to the differences from the first embodiment. The second embodiment may be implemented in combination with the first embodiment.

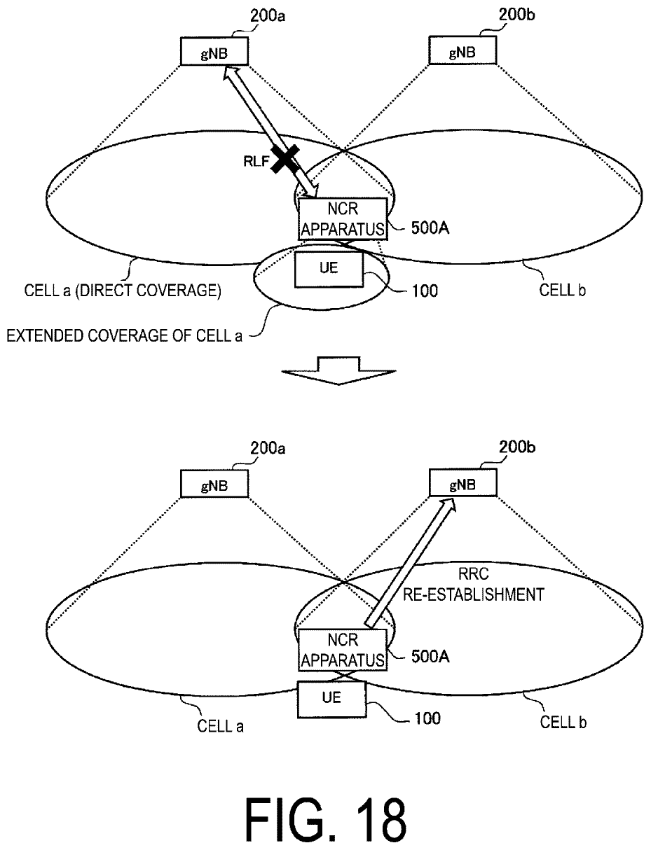

FIG. 18 is a diagram illustrating a scenario according to the second embodiment. The second embodiment is an embodiment focused on the UE 100 that performs wireless communication with the gNB 200 via the NCR apparatus 500A.

As described above, when the NCR-MT 520A detects the RLF in the cell a and re-establishes the RRC connection to another cell b, the NCR apparatus 500A (NCR-Fwd 510A) does not relay the cell a. To be more specific, the NCR-Fwd 510A is turned off, and then the NCR-Fwd 510A relays another cell b.

Here, the UE 100, which performs wireless communication with the gNB 200 via the NCR apparatus 500A, is assumed to be located in an extended coverage (also referred to as “relay coverage” or “indirect coverage”) of the cell a formed by the NCR apparatus 500A. When the NCR-MT 520A detects the RLF in the cell a and re-establishes the RRC connection to another cell b, an RLF also occurs in the wireless communication between the cell a and the UE 100. In this case, the inventors consider this to be better for the UE 100 to quickly select, for example, the cell b to which the NCR apparatus 500A is currently connected and re-establish the RRC connection. However, there is a problem in that the UE 100 does not know to which cell the NCR apparatus 500A has re-established the RRC connection.

Therefore, in the second embodiment, the gNB 200a provides the UE 100 with information on a target cell (candidate cell) for re-establishing the RRC connection when the RLF is detected, thereby facilitating the re-establishment of the RRC connection of the UE 100. Specifically, the second embodiment relates to an operation in a mobile communication system 1 in which the NCR apparatus 500A that performs wireless communication with the gNB 200a performs a relay operation of relaying wireless communication between the UE 100 and the gNB 200a. The UE 100 receives, from the gNB 200a, recommendation information (also referred to as “reference information”) indicating a cell and/or frequency that is recommended to be selected at the time of RLF in wireless communication with the gNB 200 via the NCR apparatus 500A. When the UE 100 detects the RLF, the UE 100 performs cell selection to select a target cell for re-establishing the RRC connection based on the recommendation information. This facilitates the re-establishment of the RRC connection of the UE 100.

The UE 100 may receive broadcast signaling (for example, system information block (SIB)) including the recommendation information from the gNB 200a. Since the SIB is transmitted using an MCS with higher error resistance than the dedicated signaling, even the UE 100 located in the extended coverage of the cell a can easily receive the recommendation information.

The UE 100 may generate log information regarding the RRC connection re-establishment using the recommendation information. The UE 100 may then transmit the log information to the network 5. This allows the network 5 to ascertain a usage situation of the recommendation information and use the usage situation for network optimization, for example.

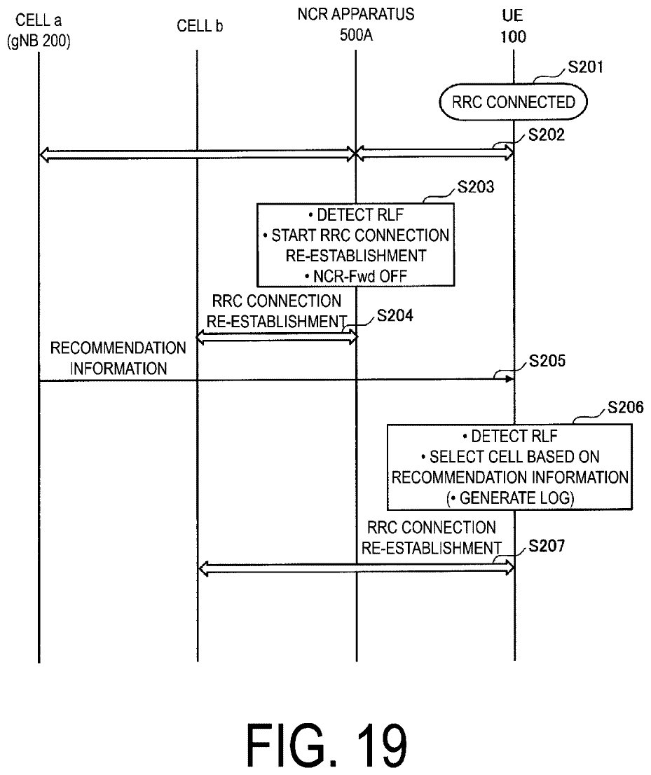

FIG. 19 is a diagram illustrating an operation example of the mobile communication system 1 according to the second embodiment. In FIG. 19, the cell a and the cell b may be managed by the same gNB 200 (that is, Intra-gNB). The cell a and the cell b may be managed by different gNBs 200 (that is, Inter-gNB).

In step S201, the UE 100 is in the RRC connected state with the cell a via the NCR apparatus 500A. That is, the UE 100 is located in the extended coverage provided by the NCR apparatus 500A. The UE 100 performs wireless communication with the cell a (gNB 200) via the NCR apparatus 500A (step S202).

In step S203, the NCR apparatus 500A detects the RLF for the cell a and starts the RRC connection re-establishment procedure. At this point, the NCR-Fwd 510A is turned off. Therefore, the relay of the link between the cell a and the UE 100 is interrupted, and the UE 100 also detects a radio problem.

In step S204, it is assumed that the NCR apparatus 500A has successfully re-established the RRC connection to another cell b of a different frequency. The gNB 200 that manages the cell a recognizes that the NCR apparatus 500A has re-established the RRC connection to the cell b. For example, when Intra-gNB is the same gNB, it can be recognized that the NCR apparatus 500A has re-established the RRC connection to the cell b. In the case of inter-gNB, the gNB 200a managing the cell a can recognize that the NCR apparatus 500A has re-established the RRC connection to the cell b by receiving a context fetch (context retrieval) message for requesting context information of the NCR apparatus 500A from the gNB 200b managing the cell b.

In step S205, the cell a (gNB 200) transmits the recommendation information for use in cell selection to the UE 100. The UE 100 receives the recommendation information. For example, the recommendation information includes information for identifying the cell b as a target cell to be selected by the UE 100 in the cell selection. The recommendation information may include a cell ID of the cell b and/or an ID of a frequency to which the cell b belongs. The recommendation information may include time stamp information (time information) for reference in log information to be described later. The cell a (gNB 200) may broadcast the recommendation information in the SIB. Alternatively, the cell a (gNB 200) may transmit the recommendation information to the UE 100 through dedicated signaling.

When the recommendation information is transmitted in the SIB, the UE 100 that is not in the extended coverage of the NCR apparatus 500A (that is, the UE 100 that is in a direct coverage of the cell a) may also receive the recommendation information. However, since such a UE 100 has a good radio state and does not perform the RRC connection re-establishment or the cell selection, the inventors consider that there is no significant impact.

The cell a (gNB 200) may transmit information on one or more neighboring cells that are candidates as the recommendation information instead of transmitting information on the cell b with which the NCR apparatus 500A has actually re-established the RRC connection as the recommendation information. In this case, the recommendation information may include a cell ID list and/or a frequency ID list. Further, in this case, the cell a (gNB 200) may transmit the recommendation information to the UE 100 through dedicated signaling before the NCR apparatus 500A detects the RLF. The dedicated signaling may be transmitted from the cell a (gNB 200) to the UE 100 via the NCR apparatus 500A (NCR-Fwd 510A).

In step S206, the UE 100 detects the RLF and selects a target cell for re-establishing the RRC connection. Here, it is assumed that the UE 100 selects the cell b based on the recommendation information.

The UE 100 may generate log information related to the recommendation information. The log information includes at least one of information indicating whether the recommendation information is provided, information indicating whether the recommendation information is used, and the content of the recommendation information. The log information may include at least one of information on the SSB in which the RLF occurs and/or information on the SSB selected in cell selection. The SSB information can be used by the network 5 to identify whether the UE 100 is in the extended coverage of the NCR apparatus 500A. The log information may include at least one of information on the cell (cell a) in which the RLF occurs and/or information on the cell (b) selected in cell selection. The log information may include at least one of information on the frequency in which the RLF occurs and/or information on the frequency selected in cell selection. The log information may include information on an elapsed time since starting T311. This allows the network 5 to identify how quickly a cell was selected.

In step S207, the UE 100 starts the RRC connection re-establishment procedure for the cell b selected in step S206. When the UE 100 succeeds in re-establishing the RRC connection, the UE 100 may transmit the log information to the cell b (gNB 200) and resume data communication. On the other hand, when the UE 100 fails to re-establish the RRC connection, the UE 100 may store the log information, and transmit the log information to the gNB 200 when the UE 100 connects to the network 5 later.

### (2.1) Variation of Second Embodiment

A Variation of the second embodiment will be described, focusing mainly on the differences from the second embodiment.

In the above-described second embodiment, when the recommendation information is transmitted in the SIB, the UE 100 that is not in the extended coverage of the NCR apparatus 500A (that is, the UE 100 that is in the direct coverage of the cell a) may also receive the recommendation information. Here, from the viewpoint of the UE 100, since the presence of the NCR apparatus 500A is not recognized, the UE 100 cannot determine whether the NCR apparatus 500A is intervening. Therefore, it is difficult for the UE 100 which has received the SIB including the recommendation information to determine whether the recommendation information should be used.

In this variation, the UE 100 receives from the gNB 200 notification information indicating whether the NCR apparatus 500A is intervening in the wireless communication between the UE 100 and the gNB 200 (that is, whether the UE 100 is in the direct coverage or in the extended coverage). The UE 100 determines whether the NCR apparatus 500A is intervening in the wireless communication between the UE 100 and the gNB 200 based on the notification information. This makes it easier for the UE 100 which has received the SIB including the recommendation information to determine whether the recommendation information should be used. For example, when the UE 100 determines that the NCR apparatus 500A is involved in the wireless communication between the UE 100 and the gNB 200 and detects the occurrence of the RLF, the UE 100 may perform cell selection based on the recommendation information.

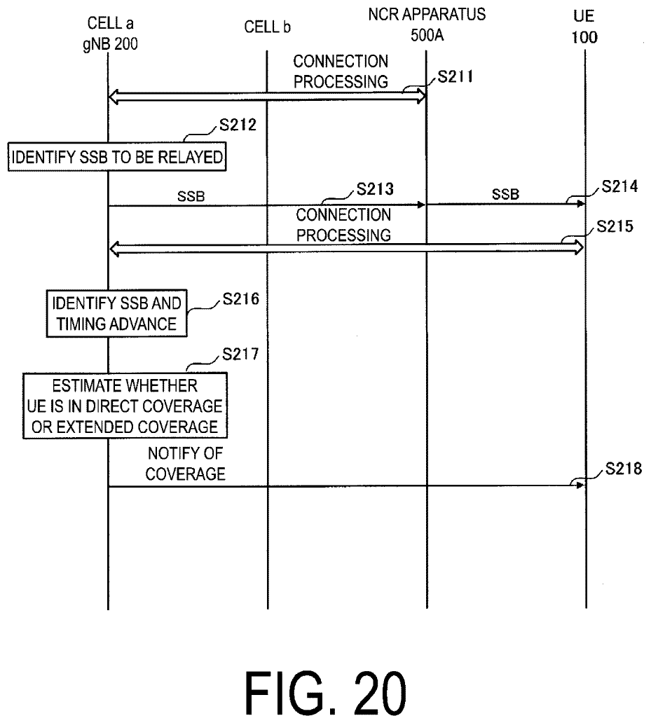

FIG. 20 is a diagram illustrating an operation example of the mobile communication system 1 according to the present variation. In FIG. 20, the cell a and the cell b may be managed by the same gNB 200 (Intra-gNB). The cell a and the cell b may be managed by different gNBs 200 (Inter-gNB).

In step S211, the NCR apparatus 500A performs a random access procedure to connect to the cell a (gNB 200). Specifically, the NCR-MT 520A of the NCR apparatus 500A selects an SSB and transmits a random access preamble associated with the selected SSB to the gNB 200 on a physical random access channel (PRACH). The timing advance is adjusted by the random access procedure. The timing advance is a parameter for adjusting the transmission timing of the NCR apparatus 500A to compensate for a propagation delay.

In step S212, the gNB 200 identifies the SSB to be relayed by the NCR apparatus 500A. The gNB 200 may transmit the SSB (step S213), and the NCR apparatus 500A (NCR-Fwd 510A) may relay the SSB to the UEFI (step S214). The UE 100 may receive the relayed SSB.

In step S215, the UE 100 performs the random access procedure for connection to the cell a (the gNB 200). Specifically, the UE 100 selects an SSB and transmits a random access preamble associated with the selected SSB to the gNB 200 on PRACH. The timing advance is adjusted by the random access procedure.

In step S216, the gNB 200 identifies the SSB to which the UE 100 belongs and the timing advance of the UE 100.

In step S217, the gNB 200 estimates whether the UE 100 is in the direct coverage or extended coverage of the cell a based on the SSB and/or timing advance identified in step S216.

In an estimation method using the SSB, the gNB 200 can estimate that the UE 100 is in the extended coverage when the SSB of the NCR apparatus 500A and the SSB of the UE 100 match. On the other hand, the gNB 200 can estimate that the UE 100 is in the direct coverage when the SSB of the NCR apparatus 500A and the SSB of the UE 100 do not match. However, this method is based on the premise that the UE 100 in the direct coverage does not receive the SSB relayed by the NCR apparatus 500A.

In an estimation method using the timing advance, when the timing advance of the UE 100 is equal to or greater than a threshold, the gNB 200 can estimate that the UE 100 is in the extended coverage. On the other hand, the gNB 200 can estimate that the UE 100 is in the direct coverage when the timing advance of the UE 100 is smaller than the threshold. Here, the threshold may be a timing advance value of the NCR apparatus 500A.

The gNB 200 may improve estimation accuracy by combining an estimation method using the SSB with the estimation method using the timing advance.

In step S218, the gNB 200 transmits a coverage notification indicating whether the UE 100 is in the direct coverage or extended coverage. The coverage notification can be transmitted to the UE 100 in dedicated signaling, such as an RRC reconfiguration message. The coverage notification may be transmitted in a SIB. The UE 100 receives the coverage notification. Step S218 may be performed simultaneously with step S205 in FIG. 19.

The coverage notification may include information indicating whether the UE 100 is in the direct coverage or extended coverage. In the case of the SIB (for example, SIB1), the coverage notification may include information indicating whether the SSB corresponding to the SIB is in the direct coverage or extended coverage. The coverage notification may include information indicating for which selected SSB the recommendation information should be applied. The coverage notification may include a threshold of timing advance (for example, a timing advance value of the NCR apparatus 500A for each SSB). In this case, the UE 100 determines that the UE 100 is in the direct coverage when the timing advance value the UE 100 manages is smaller than the threshold, and determines that the UE 100 is in the extended coverage when the timing advance value the UE 100 manages is equal to or greater than the threshold. The coverage notification may include linking information indicating which SSB is in the direct coverage and which SSB is in the extended coverage. The coverage notification may include information indicating whether the above-described recommendation information should be used during the RLF (RRC connection re-establishment).

The UE 100 may transition to the RRC idle state or an RRC inactive state based on the coverage notification. Alternatively, the UE 100 may maintain an RRC connected state.

The UE 100 may determine whether to apply or ignore the recommendation information provided in the SIB based on the coverage notification. For example, when the UE 100 determines that the UE 100 is in the extended coverage, the UE 100 takes into account the recommendation information received in the SIB in cell selection for the RRC connection re-establishment procedure after the UE 100 detects the RLF. On the other hand, when the UE 100 determines that the UE 100 is in the direct coverage, the UE 100 ignores the recommendation information received in the SIB after the UE 100 detects the RLF.

The operation of the present variation may not be an operation based on the second embodiment described above. The operation of the present variation may be useful in other scenarios in which it is desired to know whether the UE 100 is in the direct coverage or extended coverage.

### (3) Third Embodiment

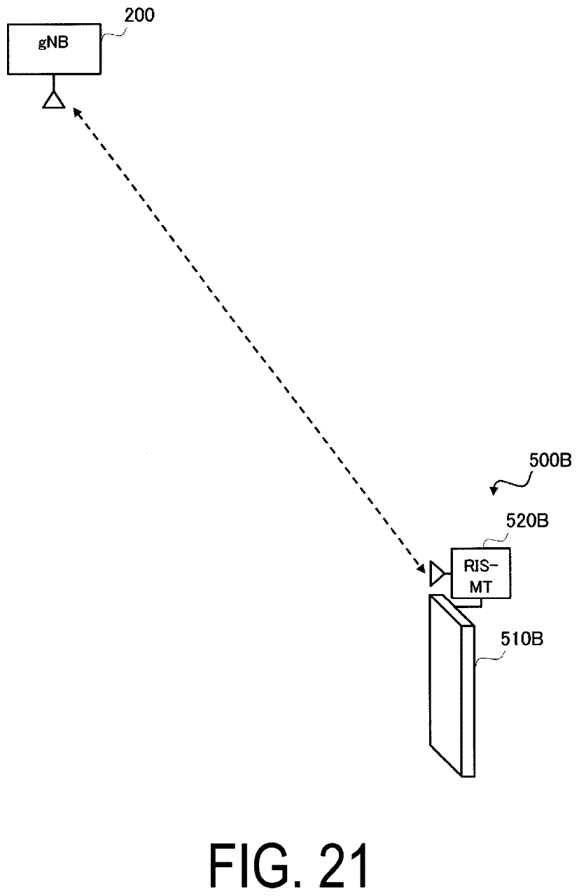

Next, differences between a third embodiment and the above-described embodiments will be mainly described. As illustrated in FIG. 21, a relay apparatus according to the third embodiment is a reconfigurable intelligent surface (RIS) apparatus 500B that changes a propagation direction of an incident radio wave (radio signal) through reflection or refraction. The “NCR” in the above-described embodiments may be read as the “RIS”.

The RIS is a type of a relay device (hereinafter, also referred to as a “RIS-Fwd”) capable of performing beamforming (directivity control) in a similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably set. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably set.

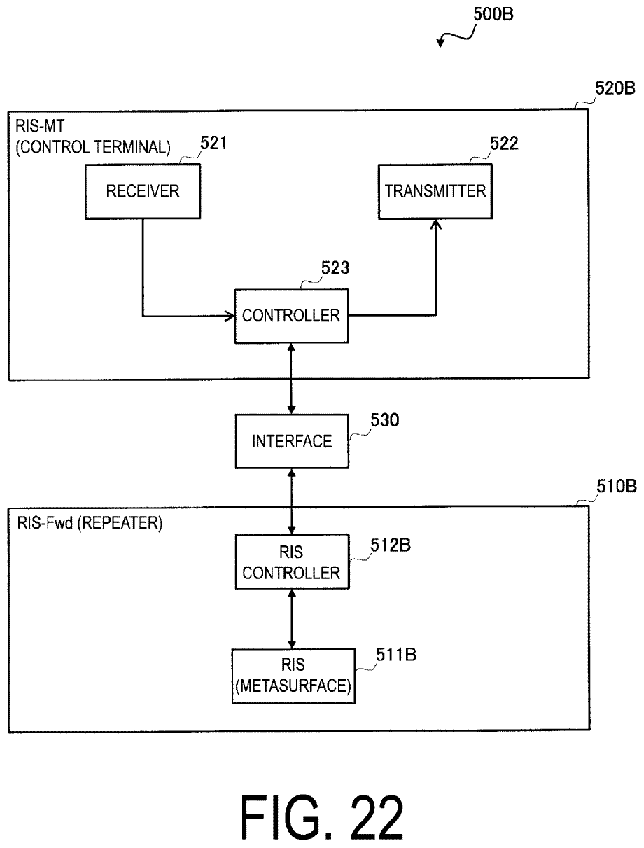

FIG. 22 is a diagram illustrating an example of a configuration of a RIS-Fwd (relay device) 510B and a RIS-MT (control terminal) 520B according to the third embodiment. The RIS-MT 520B has a receiver 521, a transmitter 522, and a controller 523. Such a configuration is the same as that of the above-described embodiment. The RIS-Fwd 510B includes a RIS 511B and a RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

### (4) Other Embodiments

In the second embodiment described above, the problem when the NCR apparatus 500A (NCR-MT 520A) detects the RLF has been described as an example. However, even when handover of the NCR apparatus 500A (NCR-MT 520A) from the cell a to the cell b fails, a problem similar to the above problem may occur. Therefore, the operation according to the second embodiment may be applied to a scenario in which the handover of the NCR apparatus 500A (NCR-MT 520A) from the cell a to the cell b is performed.

In the above-described embodiment, an example in which the relay apparatus performing relay transmission is the NCR apparatus 500A or a RIS apparatus 500B has been described. However, the relay apparatus that performs relay transmission is not limited to the NCR apparatus 500A or the RIS apparatus 500B, and may be an integrated access and backhaul (IAB) node defined in the technical specifications of 3GPP.

Each of the above-described operation flows is not limited to being performed separately and independently, but can be performed by combining two or more operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a distributed unit (DU) of the IAB node. Further, the UE 100 may be a mobile termination (MT) of the IAB node.

Further, the term “network node” mainly means a base station, but may also mean a core network apparatus or a part (CU, DU, or RU) of a base station. The network node may be configured by a combination of at least a part of a core network apparatus and at least a part of a base station.

A program for causing a computer to execute each of the processes performed by the communication apparatus according to the embodiment described above, such as the UE 100 (NCR-MT 520A and RIS-MT 520B), the gNB 200, or the relay apparatus, may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Further, circuits for executing processing performed by the UE 100 or the gNB 200 may be integrated, and at least a part of the UE 100, the gNB 200, or the relay apparatus may be configured as a semiconductor integrated circuit (chipset or system on a chip (SoC)).

Functions realized by the UE 100, the gNB 200 (network node), or the relay apparatus may be implemented in circuitry or processing circuitry that includes a general-purpose processor, a special-purpose processor, an integrated circuit, an application specific integrated circuit (ASIC), a central processing unit (CPU), conventional circuit, and/or combinations thereof programmed to realize the described functions. The processor may include transistors and other circuits and may be considered as the circuitry or processing circuitry. The processor may be a programmed processor that executes a program stored in a memory. Circuitry, unit, and means herein are hardware programmed to realize the described functions, or hardware executing the functions. The hardware may be any hardware disclosed herein or any hardware programmed to realize or known to execute the described functions. When the hardware is a processor that is considered to be a type of circuitry, the circuitry, means, or unit is a combination of hardware with software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (5) Supplements

Features relating to the embodiments described above are described below as supplements.

### Supplement 1

A communication method using a relay apparatus including a relay device configured to perform a relay operation of relaying a radio signal transmitted between a network and a user equipment, and a control terminal configured to receive a control signal used for control of the relay device from the network, the communication method including the steps of:
starting, by the control terminal in a radio resource control (RRC) connected state in a first cell, an RRC connection re-establishment procedure to a second cell based on detection of a radio link failure (RLF) in the first cell; and
controlling, by the relay apparatus, the relay operation based on whether the second cell is the same cell as the first cell when the RRC connection re-establishment to the second cell is successful.

### Supplement 2

The communication method according to supplement 1, further including receiving, by the control terminal, the control signal from the first cell before detecting the RLF, wherein the controlling includes performing recovery processing of applying the control signal to the relay operation in the second cell when the second cell is the same cell as the first cell.

### Supplement 3

The communication method according to supplement 2, further including turning off, by the relay apparatus, the relay device during the RRC connection re-establishment procedure,
wherein the control signal includes information indicating whether to turn on or turn off the relay device, and
the applying includes turning on the relay device in response to the RRC connection re-establishment being successful when the information indicates to turn on the relay device.

### Supplement 4

The communication method according to supplement 2 or 3, wherein
the control signal includes configuration information indicating whether to permit the recovery processing, and
the controlling includes performing the recovery processing in the second cell when the second cell is the same cell as the first cell and the configuration information indicates that the recovery processing is permitted.

### Supplement 5

The communication method according to supplement 4, wherein the controlling includes discarding the control signal when the second cell is the same cell as the first cell and the configuration information does not indicate that the recovery processing is permitted.

### Supplement 6

The communication method according to supplement 4 or 5, wherein, when the relay apparatus includes a plurality of relay devices, the control signal includes configuration information indicating whether to permit the recovery processing for each of the plurality of relay devices.

### Supplement 7

The communication method according to any one of supplements 1 to 6, further including turning off, by the relay apparatus, the relay device during the RRC connection re-establishment procedure,
wherein the controlling includes keeping the relay device off when the second cell is a different cell from the first cell.

### Supplement 8

The communication method according to any one of supplements 1 to 7, wherein the controlling includes discarding the control signal received from the first cell when the second cell is a different cell from the first cell.

### Supplement 9

The communication method according to any one of supplements 1 to 8, wherein
the control signal includes configuration information and/or control information related to the relay operation, and area information indicating an effective area of the configuration information and/or the control information, and
the controlling includes performing recovery processing of applying the configuration information and/or the control information received from the first cell to the relay operation in the second cell when the second cell belongs to the effective area.

### Supplement 10

A relay apparatus including:
a relay device configured to perform a relay operation of relaying a radio signal transmitted between a network and a user equipment; and
a control terminal configured to receive a control signal used for control of the relay device from the network,
wherein the control terminal:
starts a radio resource control (RRC) connection re-establishment procedure to a second cell based on detection of a radio link failure (RLF) in a first cell when the control terminal is in an RRC connected state in the first cell; and
controls the relay operation based on whether the second cell is the same cell as the first cell when the RRC connection re-establishment to the second cell is successful.

### Supplements

### 1. Introduction

In RAN #97e, a work item for the network-controlled repeater (NCR) has been approved.
RAN2 #119bis-e and RAN2 #120 have achieved significant progress with many agreements.

In this supplement, remaining open/potential problems of RAN2 regarding the NCR are discussed.

### 2. Discussion

### 2.1. NCR-Fwd ON/OFF Related Matters

### 2.1.1. Open Issue Related to RRC Release

In the RAN2 #120, the following agreement was obtained.

For NCR-Fwd ON/OFF:
When NCR-MT is in the RRC connected mode, NCR-Fwd can be turned ON or OFF according to the side control information received from the gNB.
After the NCR-MT enters the RRC inactive mode, the NCR-Fwd can be turned ON or OFF according to the last configuration received from the gNB.
Further study is needed for release to the RRC idle state.

RLF of the NCR-MT:
After the NCR-MT declares the RLF, the NCR-MT performs cell selection and triggers RRC re-establishment;
When a suitable cell is not found and the NCR-MT is in the RRC idle state, the NCR-Fwd is turned OFF;
During an RRC re-establishment procedure, NCR-Fwd is OFF.

One unsolved problem is whether it is a valid case for the gNB to release the NCR-MT to the idle state. According to the discussion in RAN2 #120, there are two camps below for the RRC state of the NCR-MT:

### Assumption 1: NCR-MT is Basically Connected:

In this assumption, the gNB will not release the NCR-MT because the NCR must always be controllable by the network. Therefore, there is a possibility that the NCR-MT is in the idle state only at an initial access (power ON) or RLF (to be precise, at the time of RRC re-establishment failure). Since a state of the NCR-Fwd due to initial access is clear (that is, the NCR-Fwd should be OFF) and the state due to RLF has already been agreed (that is, the NCR-Fwd should also be OFF), no additional NCR operation needs to be defined when the gNB releases the NCR-MT to the idle state.

### Assumption 2: The gNB can Release NCR-MT:

In this assumption, since the RRC idle state has already been agreed upon by the RAN2, the gNB can release the NCR-MT for NCR power saving, signaling overhead reduction, and the like. Accordingly, the NCR-MT may become idle due to all legacy conditions such as initial access, RLF, and RRC release. Some companies have stated that after transitioning to the idle state, the NCR-Fwd is likely to fall back to a legacy RF repeater.

Observation 1: There were two arguments related to whether an ON/OFF operation of the NCR-Fwd needs to be defined, for whether the gNB should return the NCR-MT to the idle state.

Assumption 1 is very simple because the NCR is always network controlled by the side control information and RRC signaling and there is no reason for the gNB to release the NCR-MT in a normal state. However, in smart gNB implementation, the NCR-MT may be released under specific conditions, such as power savings and signaling overhead reduction, similar to assumption 2. In this sense, a specification should allow for various gNB implementations, and operation of the NCR during idle state according to RRC release should be generally clarified.

Observation 2: In normal operation, there is no reason for the gNB to put the NCR-MT in the idle state, but the RRC release may be permitted depending on the implementation of the gNB under specific conditions.

On the other hand, for the operation of the NCR in the inactive state, after RAN2 enters WA: NCR-MT into the RRC inactive mode, NCR-Fwd can be turned ON or OFF according to a configuration last received from the gNB. That is, since the gNB can always page the NCR-MT through RAN paging, it is reasonable to align the operation of the NCR with that of the connected (that is, “no specific function enhancement”), as agreed upon by RAN2. It will be appreciated that the NCR-MT in an idle state cannot be controlled by the gNB since CN paging is required to establish an RRC connection for transmitting the side control information and the configuration. Therefore, the operation of the NCR in the idle state needs to be considered separately from the inactive state.

Observation 3: The operation of the NCR-Fwd in the inactive state is consistent with the operation in the connected state and should be different from the operation of the NCR-Fwd in the idle state.

In addition, as described in Assumption 2 above, when the NCR is not controlled by the gNB, the inventors consider that the NCR is likely to fall back to the legacy RF repeater. Since the RAN2 agrees that “the NCR-Fwd can be turned ON or OFF according to the last configuration received from the gNB”, it is clear that the inactive NCR cannot fall back to the legacy RF-repeater. In other words, the possibility of fallback to the legacy RF repeater is available only when the NCR-MT is in the idle state.

The legacy RF repeater is an implementation technology in terms of network control. Thus, when the NCR falls back to the legacy RF repeater, this is no longer a network-controlled repeater. In other words, when a node is no longer NCR (for example, when an NCR-MT transitions to an idle state), the operation of the NCR may be anything depending on the implementation.

Observation 4: According to current agreement, an NCR in an inactive state cannot fall back to the legacy RF repeater. That is, the last configuration received from the gNB must be followed, as agreed upon by the RAN2.

Observation 5: When the NCR is not controlled by the gNB (for example, when the NCR-MT transitions to the idle state), the node is likely not to be considered as an NCR from the perspective of network control.

As discussed in Observations 2 and 3, the operation of the NCR in the idle state according to the RRC release should be clarified and be different from that in the inactive state in order to enable various gNB implementations.

As described above, the RAN2 has already agreed upon “when no suitable cell is found and the NCR-MT is in the RRC idle state, the NCR-Fwd will be OFF” for the operation of the NCR due to the RLF. On this agreement, there is no significant reason to distinguish the transition to the idle state due to RRC release according to the RLF. Therefore, when the NCR-MT transitions to the idle state, the NCR-Fwd should be OFF regardless of a cause of the state transition.

Since this operation does not preclude an implementation-specific operation, the node can operate as the legacy RF repeater (that is, “fallback” operation) even when the node is not considered as the NCR (such as when the NCR-MT is idle).

Proposal 1: The RAN2 should agree to turn the NCR-Fwd OFF when the NCR-MT is released to the idle state, as in the case of the RLF.

2.1.2. Potential Problems with RRC Re-Establishment
Currently, the RAN2 agreement only assumes that the NCR-MT is always in the same cell. However, the NCR-MT is likely to change the serving cell/camping cell due to a radio state such as FR2 blockage even though NCR mobility is not supported. Therefore, when a cell with a different NCR-MT is (re-)selected, it is worth discussing what happens.

RAN2 #120 agreed to the following description.

### For NCR-MT RLF:

After the NCR-MT declares the RLF, the NCR-MT performs cell selection and triggers RRC re-establishment;
When no suitable cell is found and the NCR-MT is in the RRC idle state, the NCR-Fwd is turned OFF;
During the RRC re-establishment procedure, NCR-Fwd is OFF.

For RRC re-establishment, the following steps and potential problems are identified according to the agreement:
Step 1: The NCR-MT declares the RLF and starts cell selection and RRC re-establishment. During these procedures, NCR-Fwd is OFF as already agreed.
Step 2a: When the NCR-MT selects the same cell and the RRC re-establishment is successfully completed, the NCR-Fwd returns to ON according to the last configuration.
Step 2b: When the NCR-MT selects a different cell and the RRC re-establishment is successfully completed, it is determined whether the NCR-Fwd should be turned OFF.

For the potential problem of step 2a, since NCR has a configuration provided by the same cell, the NCR-Fwd is generally considered to be able to resume operation with the last configuration. In this case, signaling overhead for reconfiguring the NCR can be avoided.

On the other hand, since the RLF has occurred in the NCR-MT, the gNB may not prioritize such automatic resumption of the NCR-Fwd operation and, for example, in such a case, the gNB is likely to change the NCR configuration. Therefore, explicitly indicating whether the gNB should resume the operation of the NCR-Fwd with the last configuration or turn the NCR-Fwd OFF is, for example, an option as to whether to perform RRC reconfiguration in advance or to perform RRC re-establishment in time.

As another option, NCR-Fwd may be considered to be OFF even after a successful RRC re-establishment to the same cell. This is either a hard-coded definition or an indication of the gNB as described above. In this case, when the NCR-MT declares the RLF (or starts the RRC re-establishment procedure), the last RRC configuration (and the last indication using the side control information) should be discarded.

Proposal 2: The RAN2 should discuss whether NCR-Fwd will resume operation with the last configuration when RRC re-establishment to the same cell is successful.

For the potential problem of step 2b, the last configuration of the NCR-MT is provided by the last serving cell and not by the new cell. Therefore, it is easy for the NCR to be provided with a new configuration from the new cell. In this case, the NCR-MT needs to discard the last RRC configuration (and the last indication using the side control information) when selecting a different cell (or when transmitting an RRC re-establishment request towards a different cell).

Proposal 3: The RAN2 should discuss whether the NCR-MT will discard the last configuration when RRC re-establishment to a different cell is started.

2.1.3. Potential Problem with Cell Reselection
In the RAN2 #120, the following agreement was made.
The NCR-MT essentially supports cell reselection and RRM measurement in the RRC idle state and the RRC inactive state.
In Rel-18, the NCR-MT does not support handover and RRM measurement in the RRC connected state.

One potential problem with the cell reselection is priority processing for a specific cell. For the legacy RF repeater, deployment is determined by network planning and/or RF measurement on site. Thus, it is assumed that a desired cell(s) is planned for each NCR, that is, network planning determines a relationship between the serving cell and the NCR. Such a desired cell is likely to be set to the NCR by the OAM.

Observation 6: The NCR can configure the desired cell, for example, by OAM.

In this case, the NCR-MT should avoid camping (or connecting) on the undesired cell. Therefore, the NCR-MT should prioritize desirable cells over undesirable cells. While cell selection broadly allows implementation-specific operations (that is, the IAB-MT selects any suitable cell as long as the cell is appropriate), cell reselection consists of a set of deterministic operations according to a specification (inter-frequency cell reselection criterion, ranking, or the like). Therefore, standard support is required to ensure network planning of the NCR.

The simplest approach is to enhance priority processing of cell reselection. The NCR-MT may prioritize the desired cell, similarly to an MBS frequency or a side link frequency (priority may vary depending on the preference of the UE). This enhancement allows the NCR-MT to constantly make measurement to attempt to reselect the desired cell, and to minimize the possibility of camping on/connecting to undesired cells.

Another aspect is to define an NCR-specific offset for intra-frequency cell reselection (that is, within an R criterion). This is because the ranking is likely to cause the NCR-MT to reselect an undesired cell on the same frequency when the inventors consider that the NCR is likely to be deployed at a cell edge (that is, a coverage of a macro cell is likely to be extended).

Proposal 4: The RAN2 should discuss whether the NCR-MT is allowed to prioritize the desired cell (that is, the cell of interest) in the cell reselection procedure.

Another potential problem is for mobility in the inactive mode. The RAN2 agreed that “after the NCR-MT transitions to the RRC inactive mode, the NCR-Fwd can be turned ON or OFF according to the last configuration received from the gNB”. Based on this agreement, after the NCR-MT becomes inactive, the NCR-MT is likely to reselect to a different cell due to, for example, interruption of the FR2. When NCR-Fwd is OFF, there is no problem, but when NCR-Fwd is ON, the same problem as that described in section 2.1.2 is likely to occur.

Observation 7: When NCR-MT is inactive in a state in which NCR-Fwd is ON, a different cell is likely to be re-selected.

In this scenario, it is necessary to clarify how the NCR should operate. Possible options are as follows:
Option 1: NCR-Fwd remains ON at the last configuration based on current agreement matters.
Option 2: NCR-Fwd is turned OFF (or NCR-MT discards the last configuration), similar to Proposal 3 above.

Since option 1 is the same as an agreement matter that “after the NCR-MT has entered the inactive mode, the NCR-Fwd can be turned ON or OFF according to the configuration last received from the gNB”, and “WA: RRC inactive is arbitrarily supported without specific function enhancement”, option 1 may be efficient in that standardization efforts are minimized.

Option 2 is considered a reasonable operation from a technical perspective. This is because the configuration has been provided by another cell (that is, the last serving cell) and it is somewhat unnatural for the NCR-Fwd to operate in a configuration that a current cell is not recognized. This is because the reselected cell is likely to have different resources available for NCR. Therefore, taking option 2 can be said to be a fail-safe mechanism since the RAN2 also agrees that the cell reselection is a mandatory support.

Based on the above discussion, option 2 is more desirable from the perspective of technical rationality.

Proposal 5: The RAN2 should discuss whether the NCR-Fwd should be turned OFF when the NCR-MT reselects to a different cell.

Yet another potential problem is when the NCR-MT connects to an undesired cell after cell reselection or RRC re-establishment. In terms of the NCR, it is necessary to reconnect to the desired cell. From the perspective of the gNB, RRC connection with the NCR-MT ultimately makes no sense. RAN2 has already agreed that “NCR-MT does not support handover”. Therefore, the only way the gNB can take is to release the NCR-MT, but it is not guaranteed that the NCR-MT will camp on/reconnect to the desired cell because the NCR-MT will follow the cell reselection procedure after transitioning to the idle state. In this case, redirection is likely to be enhanced to cause the NCR-MT to camp on the desired cell. However, there remains a question as to whether the gNB can acquire the desired cell of the NCR (for example, a cell set by the OAM).

Proposal 6: The RAN2 should discuss whether to enhance redirection in order to move the NCR-MT from a desired cell to a desired cell (that is instead of handover).

### 2.2. Access Control Problem

### 2.2.1. Open Issue on NPN Support

In RAN2 #120, the following was agreed upon according to matters to be considered:
An NCR support indication is introduced to each PLMN in SIB1.

The inventors consider that NCR deployment in NPN is also beneficial and has potential market demand. For example, NPN frequencies are planned in high bands of FR1 (4.9 GHz) and FR2 (28 GHz) in Japan. In such frequencies, the coverage expansion by NCR is often important. As another example, NPN is likely to exhibit higher performance in a URLLC use case such as a smart factory due to its local/closed area nature. In such cases, low-latency repeaters are more suitable than high-latency relays.

From a specification perspective, the NCR support indication is assumed to be a one-bit indication added to each entry of the PLMN Identity Info List in SIB1, similar to the IAB support indication. In order to support NCR with NPN, it is only necessary to add the same indication to each entry of the NPN identity info list, similar to IAB. Therefore, standardization effort is expected to be minimal (near zero). Further, in a PLMN network, no signaling overhead occurs (that is, the NPN identity info list does not exist in such a network since the list is an arbitrary IE).

In addition, the RAN2 has already agreed to the following statement, which clearly indicates that NCR is supported in NPN.

NPN-capable NCR-MT should consider cellReservedForOtherUse for NPN-only cell determination.

In light of the above, the inventors consider that no “artificial” restriction is necessary for NCR introduction in NPN. Therefore, the RAN2 should confirm that NCR is supported in NPN, which will resolve the previous consideration matters.

Proposal 7: The RAN2 should confirm that NCR is supported in NPN. Therefore, NCR support indication is also added to each entry in the NPN identity list in SIB1.

2.2.2. Potential Problems with PRACH Resources
In IAB, a specific PRACH scene (RO) can be provided to avoid possible collision. Opportunities thereof are defined in the following IE to extend the common configuration of the UE.

Since the NCR is considered a network node like the IAB node, PRACH collision with the UE should also be avoided. For the UE in the extended coverage provided by the NCR, the preamble transmitted by the UE is forwarded to the gNB by the NCR, whereas in the case of IAB, the preamble transmitted by the UE is terminated by the IAB node. Therefore, the inventors consider this to be a more serious problem for the NCR. Therefore, the inventors consider this to be a more serious problem for the NCR in terms of PRACH collision at the gNB receiving side.

In this sense, it is worth considering whether PRACH resources separated from the UE should be provided to the NCR-MT. When this is necessary, further consideration is required as to whether the separate PRACH resources are defined by separate ROs (as in Rel-16 IAB) or defined by PRACH partitioning (that is, as part of Rel-17 RedCap, SDT, slicing, and Feature Combination Preambles defined for coverage extension).

Proposal 8: The RAN2 should discuss whether to define individual PRACH resources specific to NCR-MT.

### REFERENCE SIGNS

1: Mobile communication system
100: UE
200: gNB
210: Transmitter
220: Receiver
230: Controller
240: Backhaul communicator
500A: NCR apparatus
510A: NCR-Fwd
520A: NCR-MT
500B: RIS apparatus
511A: Wireless unit
511a: Antenna
511b: RF circuit
511c: Directivity controller
512A: NCR controller
512B: RIS controller
521: Receiver
522: Transmitter
523: Controller
530: Interface

1. A communication method using a repeater node, the repeater node comprising a repeater device configured to perform a relay operation of a radio signal transmitted between a network and a user equipment, and a control terminal configured to support a function of the user equipment, the communication method comprising:
receiving, by the control terminal, control configuration information used for control of the repeater device from the network;
starting, by the control terminal, an RRC connection re-establishment procedure based on detection of a radio link failure (RLF); and
releasing, by the control terminal, the control configuration information in response to starting the RRC connection re-establishment procedure.

2. The communication method according to claim 1,
wherein the control configuration information comprises beam control information that specifies a beam pattern for when the repeater device performs directional transmission.

3. A repeater node comprising:
a repeater device configured to perform a relay operation of a radio signal transmitted between a network and a user equipment; and
a control terminal configured to support a function of the user equipment,
wherein the control terminal comprises:
a receiver configured to receive, from the network, control configuration information used for control of the repeater device; and
a controller configured to:
start an RRC connection re-establishment procedure based on detection of a radio link failure (RLF); and
release the control configuration information in response to starting the RRC connection re-establishment procedure.

4. A non-transitory computer-readable medium storing instructions that, when executed by a processor of a repeater node, cause the repeater node to execute a process, the repeater node comprising a repeater device configured to perform a relay operation of a radio signal transmitted between a network and a user equipment, and a control terminal configured to support a function of the user equipment, the process comprising:
receiving, from the network, control configuration information used for control of the repeater device;
starting an RRC connection re-establishment procedure based on detection of a radio link failure (RLF); and
releasing the control configuration information in response to starting the RRC connection re-establishment procedure.

5. A chipset configured to execute the process stored on the non-transitory computer-readable medium of claim 4.

6. A system comprising a network, a user equipment, and the repeater node of claim 3.

7. A user equipment for controlling a repeater device, the repeater device being configured to perform a relay operation of a radio signal transmitted between a network and another user equipment, the user equipment comprising:
a receiver configured to receive, from the network, control configuration information used for control of the repeater device; and
a controller configured to:
start a radio resource control (RRC) connection re-establishment procedure based on detection of a radio link failure (RLF); and
release the control configuration information in response to starting the RRC connection re-establishment procedure.
